(19) United States
(12) Patent Application Publication
(10) Pub. No.: US 2002/0001683 A1
(43) Pub. Date: Jan. 3, 2002

(54) Enhanced anti-corrosive protective coverings and methods of use

(76) Inventor: Robert R. Dutton, Irvine, CA (US)

Correspondence Address: OPPENHEIMER WOLFF & DONNELLY LLP, 840 NEWPORT CENTER DRIVE, SUITE 700, NEWPORT BEACH, CA, 92660, US

(21) Appl. No.: 09/843,435

(22) Filed: Apr. 26, 2001

Related U.S. Application Data
(60) Provisional application No. 60/199,861, filed on Apr. 26, 2000.

(51) Int. Cl. F16B 4/00; B65B 53/00

(52) U.S. Cl. 428/35.1

(57) ABSTRACT

Protective coverings are provided that are composed of shrink-wrap and elastic stretch materials in combination with anti-corrosive materials. Highly durable, long-lived shrink-wrap materials are provided that can be used in conjunction with foam or fabric liners. The non-volatile anti-corrosive materials can be incorporated in the shrink-wrap material and/or the foam or the fabric liner. The protective coverings provided can be used to protect any article from environmental exposure, but are ideally suited for large industrial items such as aircraft, boats, vehicles, bulk materials, military equipment and electronics.

### CROSS REFERENCE TO RELATED APPLICATIONS

This application claims the benefit of U.S. Provisional Application No. 60/199,861, filed Apr. 26, 2000, hereby incorporated in its entirety by this reference.

### BACKGROUND OF THE INVENTION

The present invention relates generally to protective coverings. Specifically, the present invention relates to shrink-wrap coverings and structures made therefrom that provide a storage and shipping cover with improved environmental corrosion resistance so as to better protect covered items.

Naturally occurring and man-made materials left to withstand environmental stress unprotected eventually decay. Even the most resilient materials cannot resist the effects of wind, temperature extremes, moisture, pollutants, and ultraviolet (UV) radiation. Moreover, exposure to chemical contamination such as, but not limited to, hydrogen sulfide, carbonyl sulfide, sulfur dioxide and ozone, as well as biological agents, and radiation, can combine with physical stress and structural deformation to exacerbate the decomposition process. Recently, it has been determined that hydroxyl radicals (highly reactive charged molecules of one hydrogen atom bonded to one oxygen atom) are formed in the upper atmosphere when UV radiation reacts with ozone and water. The resulting hydroxyl radicals then react with sea salt to form chlorine gas. Chlorine gas is one of the most corrosive substances known and can combine with water to form dilute hydrochloric acid, which can significantly enhance the decay process. However, the most significant factor effecting decay rate is the composition of the material itself.

A variety of coverings have been used to protect man-made devices and machines. One of the more successful techniques for protecting items from environmental damage is shrink-wrapping. Shrink-wrapping, in general, is a process by which an article is first enclosed in a sealed plastic material that is then heated causing the shrink-wrap, or shrink-film, to contract forming a tight fitting covering over the object.

A daunting challenge facing the protective covering industry has been producing a shrink-wrap material or system capable of withstanding long-term environmental exposure and physical stress. When presently available shrink-wrap materials are properly applied, a protective covering sufficient to last approximately two years under most conditions can be achieved. However, if the shrink-wrap is exposed to environmental stress such as wind, temperature extremes, moisture, or intense UV radiation, this two-year period may be significantly shortened.

The present inventor's newly developed long-lived shrink-wrap material provided in U.S. patent application Ser. No. 09/659,275 (the “'275 application”) filed Sep. 12, 2000, has many advantages over previous shrink-wraps. The entire contents of the '275 application are herein incorporated by reference. For example, using the '275 application shrink wrap material and methods, an article can be provided with extended physical protection from direct solar damage, rain, wind, sand storms and salt water in addition to other potential environmental hazards. However, the extended storage periods obtainable with these new ultra-durable shrink-wrap materials provide create new challenges for protecting shrink-wrapped articles from the potential corrosive effects of reactive compounds trapped within the shrink-wrap microenvironment. Thus, there is a need for methods and materials to provide a shrink-wrapped article protection from the potentially corrosive internal shrink-wrap microenvironment for periods equal to or greater than the life expectancy of the present inventor's new shrink-wrap materials.

Methods and materials intended to minimize the corrosive effects associated with internal shrink-wrap microenvironments are disclosed in several United States Patents. However, each patent describes materials or methods that are either short-lived or difficult to apply. Consequently, corrosion inhibitors used in the past are not suited for use with the surprisingly durable shrink-wrap materials disclosed in the present inventor's '275 application. For example Todt describes a shrinkable or stretchable film having a non-woven fabric bonded thereto in U.S. Pat. No. 5,736,231 (the “'231 patent”) and in U.S. Pat. No. 5,623,812 (the “'812 patent”). The '231 patent further describes incorporation vapor corrosion inhibitors (VCI) into the adhesive which is used to bond the non-woven fabric to the shrink-wrap film. This process must be done immediately prior to use to prevent the volatile additives from dissipating into the environment. Consequently, it is not possible to manufacture and store large quantities of the anti-corrosive shrink-wrap film ready for immediate deployment such as required by the military and disaster relief organizations.

Several United States patents are assigned to Cortec Corporation of St. Paul Minn. that disclose vapor corrosion inhibitor containing products including U.S. Pat. No. 6,028,160 (the “'160 patent”) and U.S. Pat. No. 5,855,975 (the “'975 patent”). Both the '160 and '975 patents utilize the vapor phase corrosion inhibitor material described in U.S. Pat. No. 5,139,700 (the “'700 patent”). The VCIs of the '700 patent are specifically designed to be deposited on the surfaces of ferrous and non-ferrous metals. Consequently, a film of potentially toxic materials is left on the material to be protected necessitating thorough post-treatment cleaning. Moreover, only metallic surfaces are protected by the VCI disclosed in the '700 patent and used in the '160 and '975 patents. Therefore, non-metallic components and surfaces remain susceptible to the damaging effects of chlorine gas, hydrogen sulfide, carbonyl sulfide, sulfur dioxide and ozone. Therefore, while VCIs may offer short-term protection to metallic surfaces, they are difficult to apply, relatively unstable, leave potential toxic residues behind, and only partially protect articles from corrosive compounds.

Consequently, the extended storage time provided for by the present inventor's shrink-wrap material has created a need for long term corrosion prevention. Moreover, the long-term corrosion inhibitors must be capable of being easily and stably integrated into the present inventor's new shrink-wrap. Furthermore, it would be preferable if the anti-corrosive shrink-wrap material could literally intercept potentially corrosive compounds before they enter the shrink-wrap microenvironment. This would eliminate the necessity to deposit anti-corrosive materials directly on metallic surfaces and provide a shrink-wrap microenvironment free of corrosive compounds. Consequently, all types of materials and compounds would be protected.

Therefore, it is an object of the present invention to provide protective coverings that resist deterioration caused by longer-term exposure to environmental, chemical, physical, radiation and thermal stress sources.

It is another object of the present invention to provide protective coverings that create an anti-corrosive microenvironment.

It is yet another object of the present invention to provide protective coverings that reduce biological activity within an enclosed article.

It is another object of the present invention to provide protective coverings that provides electrostatic discharge protection for an enclosed article.

It is another object of the present invention to provide protective coverings that are environmentally safe while extending the useful protection period and storage life of the shrink-wrap.

It is another object of the present invention to provide protective coverings that are inexpensive to manufacture, easy to deploy, and retain their anti-corrosive properties during extended storage periods.

It is still another object of the present invention to provide protective coverings that can protect an object from the corrosive elements associated with sea water, specifically from chlorine gas formed from the reaction of hydroxyl radicals with sea salt.

It is yet another object of the present invention to provide a stable, highly protective long-term shrink wrap material suitable for protecting, but not limited to, aircraft, boats, military and civilian vehicles, consumer goods, foodstuffs and buildings.

### BRIEF SUMMARY OF THE INVENTION

These and other features of the present invention are achieved by the protective coverings of the present invention. In one embodiment of the present invention the protective coverings are anti-corrosive shrink-wrap systems that, in accordance with a broad structural aspect of the invention, includes long-term shrink-wrap material having non-volatile anti-corrosive materials incorporated therein and/or a layer attached thereto. Specifically, the protective coverings of the present invention provide prolonged protection to articles stored therein against extreme environmental exposure. This surprisingly effective protection is accomplished through the combined effects of long-lasting, durable shrink-wrap materials which are provided with non-volatile anti-corrosive compounds in accordance with the teachings of the present invention.

The non-volatile anti-corrosive materials of the present invention consist of sacrificial metals and other radical scavengers that can be dispersed within the shrink-wrap material itself.

In another embodiment of the present invention these anti-corrosive materials are dispersed within a foam material that is covered with, or integrated with, the shrink-wrap film of the present invention.

In another embodiment of the present invention the non-volatile anti-corrosive materials are incorporated within a fabric liner which is adhered to the protective shrink-wrap material of the present invention.

In another embodiment of the present invention the non-volatile anti-corrosive materials are extruded into a fiber that is then formed into a fabric and then adhered to the protective shrink-wrap material of the present invention.

In another embodiment of the present invention the non-volatile anti-corrosive materials are contained within a resin that is co-extruded with protective shrink-wrap materials of the present invention.

In yet another embodiment of the present invention the non-volatile anti-corrosive materials are contained within a foam liner that is laminated to the protective shrink-wrap material of the present invention.

In another embodiment of the present invention the protective covering is an elastic stretch wrap that has been provided with the anti-corrosive materials in accordance with the teachings of the present invention.

The protective coatings of the present invention can be used to provide long-term durable, anti-corrosive protection for such articles as, but not limited to, aircraft, boats, military and civilian vehicles, satellites, buildings, materials, construction equipment, consumer goods, electronics, and foodstuffs.

### DETAILED DESCRIPTION OF THE INVENTION

The present invention is useful for providing items with a versatile, resilient long-term protective covering that will protect the item encased therein from exposure to environmental, chemical, physical, radiation and thermal sources of stress. Moreover, the present invention also provides anti-corrosive protection for items encased within the protective covering of the present invention. The protective coverings of the present invention are composed of an outer compressible wrap with or without an inner liner laminated thereto. Non-volatile sacrificial metals and/or other types of scavenging agents may be incorporated within the compressible outer layer and/or incorporated with liners attached to the compressible wrap such as, but not limited to, foams and fabrics. Examples of the compressible wrap include materials such as shrink-wrap that can be shrunk by heat or other means and materials such as elastic stretch wrap whose internal elasticity causes the material to encase an object. Suitable elastic stretch wraps can be made using materials and methods known to those skilled in the art such as those described in U.S. patent Ser. No. 5,969,070 issued to Waymouth et al. on Oct. 19, 1999 and U.S. patent Ser. No. 5,594,080 issued to Waymouth et al on Jan. 14, 1997, both of which are herein incorporated by reference in their entirety. Anti-corrosive protection is achieved by incorporating non-volatile sacrificial metals within the materials of the protective coverings.

In one embodiment of the present invention, shrink-wrap materials form the compressible outer surface. Shrink-wrap coverings currently used to protect items during shipping, handling and storage are known by those skilled in the art to have a maximum useful life of approximately two years when subjected to normal environmental, chemical, physical, radiation, and thermal stresses. However, the inventor of the present invention has developed methods and materials that result in extraordinarily long-lived shrink-wrap coverings. With the development of a long-lived shrink-wrap material, the present inventor surprisingly encountered corrosion due to corrosive contaminants trapped within the shrink-wrap microenvironment and those contaminants that pass through the shrink-wrap covering.

During the shrink-wrapping process, air is trapped within the internal shrink-wrap microenvironment. The trapped air may contain corrosive gases such as, but not limited to, hydrogen sulfide, carbonyl sulfide, sulfur dioxide, hydrogen chloride, and chlorine. The corrosion process is initiated when corrosive gases, or water vapor having corrosive gases or ions dissolved therein, react with ferrous metals, non-ferrous metals and other materials. The present invention helps to neutralize these corrosive elements in the shrink-wrap film microenvironment by providing a polymer matrix containing sacrificial metals such as, but not limited to copper, carbon black, iron, cobalt, manganese, and aluminum incorporated within the shrink-wrap materials.

In order to protect the enclosed article from corrosion, corrosion inhibitors such as non-volatile sacrificial metals are incorporated in the shrink-wrap material. When the corrosive contaminants come in contact with these sacrificial metals, the contaminants react with these metals and are subsequently neutralized. As a result of having these sacrificial metals incorporated within the shrink-wrap material, a corrosive-free environment is created as the corrosive elements present within the shrink-wrapped environment are neutralized by physical contact with the corrosion neutralizing resin. More importantly, an anti-corrosion barrier is created in the protective covering of the present invention to further prevent corrosive gas migration. Corrosive elements in the exterior environment are immediately neutralized as they pass through the shrink-wrap thus preventing contamination of the protected article.

As previously discussed shrink-wrapping traps air in the shrink-wrap microenvironment. That air may also contain corrosive gases and water vapor therefore placing the corrosion susceptible materials at risk. However, the volume of trapped air within the shrink-wrap microenvironment is generally minimal, consequently the large surface area of sacrificial metal containing shrink-wrap easily neutralizes the trapped corrosive contaminants.

In one embodiment of the present invention, suitable corrosion inhibitors include, but are not limited to, those compounds described and disclosed in U.S. patent Ser. No. 5,154,886 (the “'886 patent”) issued Oct. 13, 1992 to Franey, et. al. and U.S. patent Ser. No. 4,944,916 issued Jul. 31, 1990 to Franey, the entire contents of both patents are hereby incorporated by reference. The corrosion inhibitors of the '886 patent are essentially composed of three components. Component A is polymer such as polyethylene and polypropylene. Component B is carbon black which is defined as a finely divided form of carbon such as that obtained by the incomplete combustion of natural gas, and Component C is a suitable metal such as copper, iron, cobalt, manganese, and alloys of these metals. The particular polymer chosen is not critical, but the polymer is chosen so that the required loading with carbon black and metal does not substantially degrade the polymer film. Substantial degradation in the context of this invention is loss of mechanical coherency.

The polymer matrix is formulated to include impregnated particles of carbon black and of a metal that undergoes chemical bonding with the carbon and in preferred embodiments also with the polymer. Typical loading percentages of the carbon black and metal are 1-6 wt % and 10-30 wt %, respectively. Loading percentage is defined as the weight percent (wt %) of additive relative to the polymer weight in the absence of additive. For highly conducting carbon black such as Ketjen black loading percentages in the range of 1-5 wt % and metal loading percentages in the range of 10-40 wt % are employed. For less conductive carbon black, higher loading percentage of carbon black should be used. The exact percentages depend on the particular carbon black and metal used. A controlled sample is easily employed to determine an appropriate composition ratio for a given metal and carbon black material. Various carbon black materials are available, but highly oxidized and highly porous carbon blacks are advantageous due to their high and reproducible conductivity. The use of carbon black with, for example, copper or iron provides electrostatic charge protection in addition to a barrier to water vapor. Also, it affords corrosion protection from hydrogen sulfide, chlorine, hydrogen chloride, and other corrosive gases.

The carbon black and the metal material should be introduced into the polymer matrix in the form of particles through conventional techniques such as low temperature mechanical mixing and extrusion. Formation of the protecting configuration is also accomplished by conventional techniques such as film blowing, film casting, and vacuum forming. It is possible to introduce additional additives such as molding and stabilizing constituents to adjust material properties such as mold release characteristics and oxidative degradation rate.

In another embodiment of the present invention, the protective coverings comprise foam laminated to shrink-films. The foam contains sacrificial metals that neutralize corrosive contaminants. The foam is then laminated to a suitable shrink-wrap material, such as, but not limited to, the shrink-wrap provided in the '275 patent application. The foam component of the protective coverings protects the article from damage during shipping and handling by acting as an insulating shock absorber. Moreover, the foam layer also provides thermal insulation, added rigidity to prevent tearing or puncturing as well as having anti-corrosive properties.

Alternatively, the foam may be pre-shaped to meet the specific needs of the article being shrink-wrapped. For example, the foam may be shaped to minimize contact with the article's outer surface, vents, shunts, or conduits may be formed in the protective coverings to provide ventilation for the internal shrink-wrap microenvironment. These vents, shunts, or conduits would also allow air to be vacuumed out the internal shrink-wrap microenvironment or allow inert gases such as, but not limited to, nitrogen, argon, xenon and helium to be introduced into the internal shrink-wrap microenvironment. Alternately, the foam may also be shaped to form structures such as tents, storage sheds, or covers for aircraft, vehicles, or boats.

As those skilled in the art will appreciate, the foam layer may be applied to the article being protected and the shrink-wrap material subsequently applied thereon. The shrink-wrap material is then heated to form a shrunken covering. However, it is contemplated that one-step rather than two steps be used to apply the shrink wrap system.

As those skilled in the art will appreciate, the aforementioned protective coverings may comprise a compressible wrap having non-volatile sacrificial metals incorporated therein. The compressible wrap is then laminated to a foam material such that the sacrificial metals reside in both the compressible wrap in addition to the foam, or in the compressible wrap alone. The protective covering is then applied to the surface of the article to be protected and shrunk to provide a protective, corrosion resistant covering.

In another embodiment of the present invention the protective coverings of the present invention are provided with an additional external coating which further enhances the long-term protection afforded the articles enclosed within the shrink-wrap/protective coverings of the present invention.

In yet another embodiment of the present invention, the shrink-wrap system comprises a non-woven fabric laminated to a shrink-film. The fabric is made from a resin containing a polymer matrix that would provide corrosion protection. The fabric is then laminated to the long-term shrink-wrap. The fabric provides protection against abrasion, physical abuses, and heating. The fabric also provides additional strength as it prevents tearing and puncturing.

In another embodiment of the present invention, a substrate is extrusion laminated with a polymer matrix layer containing sacrificial metals. The substrate comprises a porous fabric made from polyester, polypropylene, or other fabric materials that are preferably heat resistant. The polymer matrix layer is melted and basically cast onto the substrate. The extrusion lamination process may include a vacuum to draw the melted polymer matrix layer into the fiber pores. Those skilled in the art will appreciate that the substrate, rather than the polymer matrix layer, may be heated to cause the polymer matrix layer to melt on to the substrate. Additionally, an external heat source may be employed and applied to the polymer matrix to cause the polymer matrix layer to become semi-molten.

The extrusion-laminated fabric may be then attached to a shrink film layer. The shrink film layer may be applied by a heat lamination process or by using adhesives. It is contemplated that the shrink film and the extrusion-laminated surface are in continuous contact. However, it is also contemplated that intermittent use of heat or adhesives to attach the two layers at various contact points. Those skilled in the art will appreciate that the shrink film that is laminated to the extrusion-laminated fabric may also contain sacrificial metals. The extrusion lamination process is advantageous because the manufacturing process is simplified. For instance, adhesives may be eliminated from the process of combining a fabric layer to a polymer matrix layer, and fewer polymer matrix layers may be required. That is, when two disparate layers are attached to one another, an adhesive layer may be required to attach the layers together. When corrosive gases from the exterior environment penetrate the protective coating, they first penetrate the shrink film layer and then contact the anti-corrosive layer and then they contact the adhesive layer. The adhesive layer acts as a boundary separating the two layers that were attached together. Thus, polymer matrix layer that contacts the inner environment must also be provided. In contrast, the extrusion-laminated fabric eliminates the need for an adhesive layer or multiple anti-corrosive layers because both sides of the fabric are impregnated with the polymer matrix having sacrificial metals incorporated therein. As a consequence, less polymer matrix material is required to impart anti-corrosive protection resulting in a manufacturing process that is simplified and economical.

In another embodiment of the present invention, the shrink-wrap system may be co-extruded with different resins depending on the desired material characteristics or application. For instance, anti-corrosion resin may be extruded with a waterproof layer, which would provide added resistance to moisture entering the internal shrink-wrap environment. The shrink-wrap material may be adapted to provide long term storage protection or for short-term protection. As those skilled in the art will appreciate, various resins may be co-extruded to achieve the desired characteristics of the shrink-wrap system.

In yet another embodiment of the present invention, the protective coverings comprise at least one layer of material. That is, the protective coverings are composed of a plurality of layers. In one embodiment, shrink film is provided as the outer layer that is exposed to the exterior environment and the anti-corrosive layer is the inner layer that contacts the inner environment. It is contemplated that the shrink film be a LDPE/LLDPE shrink film or a shrink film as disclosed in the '275 application. In another embodiment, two LDPE/LLDPE shrink film layers were co-extruded with at least one polymer matrix layer. The two shrink film layers are each 3-mil standard LDPE/LLDPE shrink film with a 1-mil polymer matrix layer. The anti-corrosive layer may be sandwiched between the shrink film layers or the anti-corrosive layer may be innermost layer. Those skilled in the art will also appreciate that the polymer matrix layer may vary in thickness. It is contemplated that the polymer matrix layer be at least 0.1 mil thick, preferably at least 0.5 mil thick.

Those skilled in the art will appreciate that the protective coverings of the present invention may be made by a variety of methods. According to one method of the present invention, the polymer matrix may be formed by adding appropriate amounts of polymer, carbon black, and metal. The polymer matrix may be extruded to form an anti-corrosive film. The film may be laminated to a shrink film, foam, fabric, or other layers of the protective covering. The present invention also contemplates that adhesives may be used to attach the anti-corrosive film layer to the other layers of the protective coating.

According to another method of the present invention, an anti-corrosive film is made by the aforementioned process. The anti-corrosive film is subsequently chopped to form anti-corrosive pellets. The anti-corrosive pellets are combined with the constituents that make up the shrink film or foam layers. The mixture of shrink film or foam constituents and the anti-corrosive pellets are co-extruded to form an anti-corrosive shrink film or anti-corrosive foam layer. The anti-corrosive shrink film may be laminated or attached to foam layers, inner liners, fabric layer, elastic stretch wrap layer, or the like to form a protective covering. In yet another method of the present invention, carbon black and non-volatile sacrificial metals may be added to and co-extruded with the constituents of the shrink film, foam layer, or elastic stretch wrap.

While the invention has now been described with reference to several embodiments, those skilled in the art will appreciate that various substitutions, omissions, modifications and changes may be made without departing from the scope or spirit thereof. Accordingly, it is intended that the foregoing description be considered merely exemplary of the invention and not a limitation thereof.

What is claimed is:

1. A protective covering comprising:
a compressible wrap having non-volatile sacrificial metals incorporated therein.

2. The protective covering of claim 1, wherein said compressible wrap is shrink-wrap film.

3. The protective covering of claim 1, wherein said compressible wrap is an elastic stretch wrap.

4. A protective covering comprising:
a compressible material provided with a layer having non-volatile sacrificial metals incorporated therein.

5. The protective covering of claim 4, wherein said layer is made of foam.

6. The protective covering of claim 4, wherein said layer is non-woven fabric.

7. The protective covering of claim 6, wherein said fabric is composed of fibers extruded from an anti-corrosive resin.

8. The protective covering of claim 6, wherein said fabric fiber is laminated with an anti-corrosive resin.

9. A Protective covering comprising:
a compressible material co-extruded with a resin having non-volatile sacrificial metals incorporated therein.

10. A method of creating an anti-corrosive environment comprising:
applying a non-volatile anti-corrosive shrinkable material to the surface of an article to be protected; and
shrinking said shrinkable material to form a shrunken covering.

11. A method of creating an anti-corrosive environment comprising:
applying a shrinkable material to the surface of an article to be protected;
shrinking said shrinkable material to form a shrunken covering; and
providing said shrunken covering with a protective coating.

12. A protective covering comprising:
a plurality of adjoining layers, wherein at least one layer is an anti-corrosive layer and at least one layer is compressible layer.

13. The protective covering of claim 10, wherein said at least one layer is a shrink wrap film.

14. The protective covering of claim 11, further including at least one foam layer.

15. The protective covering of claim 10, wherein said at least one layer is a nonwoven fabric.

16. The protective covering of claim 13, further including at least one foam layer.

17. The protective covering of claim 10, wherein said at least one layer is an elastic stretch wrap.

18. A method of forming a protective covering comprising:
providing a substrate;
placing an anti-corrosive resin on said substrate; and
melting said anti-corrosive resin onto said substrate forming an extrusion laminated material.

19. The method of claim 16, wherein said substrate is a polyester fabric or a polypropylene fabric.

20. The method of claim 16, further including laminating a shrink film layer to said extrusion laminated material.

21. The method of claim 18, wherein said melting step further includes applying a vacuum causing said anti-corrosive resin to be drawn into the pores of said substrate.
